(19) United States
(12) Patent Application Publication
(10) Pub. No.: US 2007/0205061 A1
(43) Pub. Date: Sep. 6, 2007

(54) Disc brake

(75) Inventor: Haruo Yagi, Tokyo (JP)

Correspondence Address: DRINKER BIDDLE & REATH (DC), 1500 K STREET, N.W., SUITE 1100, WASHINGTON, DC, 20005-1209, US

(73) Assignee: Akebono Brake Industry Co., Ltd.

(21) Appl. No.: 11/711,001

(22) Filed: Feb. 27, 2007

(30) Foreign Application Priority Data
Mar. 1, 2006 (JP) P. 2006-055257

(51) Int. Cl. F16D 65/40

(52) U.S. Cl. 188/73.38; 188/73.37

(57) ABSTRACT

A pad clip is made by an elastic plate and includes a base plate portion, and a pair of elastic plate portions folded to bend in the same direction from both end portions of the base plate portion. The pad clip is provided with an elastic force in a direction of expanding an interval between the two elastic plate portions. In a state of elastically contracting the interval between the two elastic plate portions, the pad clips are inserted to inner sides of guide recessed portions formed at a pressure plate constituting the brake pad, thereby, the two elastic plate portions are elastically pressed to inner faces of the two guide recessed portions to thereby mount the pad clip to the pressure plate.

This application claims foreign priority from Japanese Patent Application No. 2006-055257, filed on Mar. 1, 2006, the entire contents of which are hereby incorporated by reference.

### BACKGROUND OF THE INVENTION

1. Field of the Invention

The present invention relates to an improvement in a disc brake used for braking an automobile. Specifically, by devising a shape of a pad clip for preventing rattle of a portion of engaging a support member and a pressure plate of a brake pad displaceably integrated to the support member, the invention achieves promotion of a performance of handling a part mounted with the pad clip.

2. Related Art

As a disc brake used for braking an automobile, in a background art, there are known various structures thereof described in, for example, Patent References 1 through 9. FIGS. 20 through 22 show a disc brake described in Patent Reference 9 thereof. First, a simple explanation will be given of the background art structure.

According to the disc brake, a caliper 3 is supported by a support member 2 fixed to a suspension in a state of being contiguous to a rotor 1 rotated along with a wheel displaceably in an axial direction (obverse and reverse direction of FIG. 20, up and down direction of FIG. 21) of the rotor 1. The support member 2 supports two brake pads 4a, 4b on an outer side (outer side with regard to a width direction of a vehicle) and an inner side (center side with regard to the width direction of the vehicle) by interposing the rotor 1 respectively in a state of capable of being displaced in the axial direction of the rotor 1. Therefore, in an illustrated example, portions of the support member 2 are formed with guide projected portions 5, 5 in a state of being projected to pressure plates 6a, 6b constituting the two brake pads 4a, 4b. Further, portions of the two pressure plates 6a, 6b and two end edge portions in a direction of rotating the rotor 1 are formed with guide recessed portions 7, 7 in a state of being recessed relative to the supports 2. Further, the respective guide recessed portions 7, 7 and the respective guide projected portions 5, 5 are engaged by way of pad clips 8, 8 made of an elastic material of stainless spring steel or the like. Further, a front end face of a piston (not illustrated) fitted to a cylinder portion of the caliper 3 is butted to the pressure plate 6b constituting the brake pad 4b on the inner side. Further, an inner side face of a caliper claw 9 formed at an end portion on an outer side of the caliper 3 is brought into contact with the pressure plate 6a constituting the brake pad 4a on the outer side.

When braking is carried out, the brake pad 4b on the inner side is pressed to an inner side face of the rotor 1 by the piston. As reaction of the pressing, the caliper 3 is displaced to the inner side, and therefore, the caliper claw 9 presses the brake pad 4a on the outer side to an outer side face of the rotor 1. As a result, the rotor 1 is strongly squeezed from the both sides by linings 10a, 10b of a pair of the brake pads 4a, 4b to thereby carry out braking. A brake torque supplied to the respective brake pads 4a, 4b in accordance with friction between the respective linings 10a, 10b and the rotor 1 is supported by the support member 2 supporting the pressure plates 6a, 6b of the respective brake pads 4a, 4b.

The respective pad clips 8, 8 interposed between the respective guide recessed portions 7, 7 and the respective guide projected portions 5, 5 are elastically stretched between the respective guide recessed portions 7, 7 and the respective guide projected portions 5, 5 to thereby prevent the respective brake pads 4a, 4b from being rattled relative to the support member 2. Further, by fabricating the respective pad clips 8, 8 by plate members having corrosion resistance of stainless steel plates or the like, even when the support member 2 and the two pressure plates 6a, 6b are made of steel, the support member 2 and the pressure plates 6a, 6b are prevented from being rusted. Further, displacement of the two pressure plates 6a, 6b relative to the support member 2 is made to be carried out firmly.

In the case of the structure described in Patent Reference 9 as mentioned above, in a state before mounting the two brake pads 4a, 4b to the support member 2, as shown by FIG. 22, the respective pad clips 8, 8 are tacked to a side of the support member 2. When the respective pad clips 8, 8 are carried at inside of a factory of assembling the disc brake in a state of being mounted to the side of the support member 2 which is comparatively large-sized and weighted part in this way, there is a possibility that the respective pad clips 8, 8 collide with other article to be detached, or damaged. In the case of the background art structure shown in FIG. 22, by engaging recessed portions 11 formed at the support member 2 and front end portions of elastic claws 12, the respective pad clips 8, 8 are made to be difficult to be detached. However, by forming the recessed portion 11 at the support member 2, cost of fabricating the disc brake including the support member 2 is increased, a restriction in view of design is imposed or the like, which is not preferable. Further, when an operator handles the support member 2 which is attached with the pad clips 8, 8 having sharp ends and weighted by the hand for assembling, there is a possibility that the operator is injured at the hand, the finger or the like by the sharp end.

[Patent Reference 1] JP-A-52-072067

[Patent Reference 2] JP-A-57-006138

[Patent Reference 3] JP-A-57-083732

[Patent Reference 4] JP-A-11-344057

[Patent Reference 5] JP-A-2002-295538

[Patent Reference 6] JP-A-2004-353815

[Patent Reference 7] JP-A-2005-315421

[Patent Reference 8] JP-U-52-080389

[Patent Reference 9] JP-Y-01-24441

### SUMMARY OF THE INVENTION

One or more embodiments of the present invention provide a disc brake to realize a structure in which an operator is difficult to be injured at the hand, the finger or the like by making a tacked pad clip difficult to be detached and improving a performance of handling a brake pad tacked with the pad clip even in a state before attaching a brake pad to a support member.

In accordance with one or more embodiments of the present invention, a disc brake is provided with a support member fixed to a vehicle body adjacent to a rotor rotated along with a wheel, and a brake pad supported by the support member. The brake pad is guided movably in an axial direction of the rotor by engaging a guide projected portion formed at a portion of the support member in a state of being projected to a pressure plate of the brake pad, and a guide recessed portion formed at a portion of the pressure plate in a state of being recessed relative to the support member. In braking, the brake pad is pressed to a side face of the rotor.

Particularly, in accordance with one or more embodiments of the present invention, in a first aspect of the invention, the pad clip is made by an elastic plate of a stainless steel plate or the like, and includes a base plate portion and a pair of elastic plate portions folded to bend in the same direction from both end portions of the base plate portion. The pad clip is provided with an elastic force in a direction of expanding an interval between the two elastic plate portions. The pad clip is mounted to the pressure plate by inserting the two elastic plate portions to an inner side of the guide recessed portion in a state of elastically contracting the interval between the two elastic plate portions and elastically pressing the two elastic plate portions to side faces of inner faces of the guide recessed portions opposed to each other with regard to a radial direction of the rotor.

Further, in a second aspect of the invention, at least a pair of hold plate portions folded to bend to the pressure plate may be formed at both end edge portions of any of plate portions constituting the pad clip with regard to the axial direction of the rotor. By squeezing the pressure plate from both obverse and reverse sides by the hold plate portions, positioning of the pad clip with regard to an obverse and reverse direction of the pressure plate is achieved.

In a third aspect of the invention, an end edge portion of any of the plate portions constituting the pad clip with regard to the axial direction of the rotor may be formed with a guide plate portion inclined in a direction of being remote from the guide projected portion as being remote from any of the plate portions.

In addition, in a fourth aspect of the invention, a front end portion of the guide plate portion may be folded to bend. In this case, regardless of wear of a lining constituting the brake pad, a sharp end edge of the guide plate portion and a side face of the rotor are prevented from rubbing each other.

In a fifth aspect of the invention, a portion of the pad clip may be provided with a plate portion for a wear indicator projected to the side face of the rotor. In this case, a front end edge of the plate portion for the wear indicator is arranged at a wear allowable limit thickness position of the lining constituting the brake pad.

Moreover, in a sixth aspect of the invention, a stepped portion may be made to be present between a front half portion and a base half portion of the guide projected portion by folding to bend the front half portion relative to the base half portion. In this case, the portion of the pressure plate is provided with a locking hook portion folded to bend to an opening portion of the guide recessed portion. Further, based on an engagement between the locking hook portion and the stepped portion, based on friction between the rotor and the lining in braking, at least a portion of a brake torque applied to the brake pad is made to able to be supported thereby. Further, the pad clip is prevented from being drawn from the opening portion of the guide recessed portion based on an engagement between a front end edge of any of the elastic plate portions and the locking hook portion.

According to the disc brake of one or more embodiments constituted as described above, there can be realized a structure making the tacked pad clip difficult to be detached, further, improving a performance of handling the brake pad tacked with the pad clip and making an operator difficult to be injured at the hand, the finger or the like even in a state before mounting the brake pad to the support member.

That is, the pad clip is mounted to the brake pad constituting a comparatively small-sized and light-weighted part in the support member and the brake pad integrated by way of the pad clip, and therefore, in carrying at inside of the factory of assembling the disc brake, even when the pad clip collides with other article, the pad clip is difficult to be detached or damaged.

Further, since a member mounted with the pad clip having a sharp end is the small-sized and light-weighted brake pad, the member is easy to be handled, and even when an operator handles the member by the hand for assembling, the operator is difficult to be injured at the hand, the finger or the like by the sharp end.

Further, according to the structure of the second aspect, not only the pad clip can be prevented from being detached from the brake pad further firmly but also even in a state after integrating the brake pad and the support member, the pad clip can be prevented from being shifted from a proper position.

Further, according to the structure of the third aspect, even when the brake pad is inclined relative to the support member by uneven wear of the lining constituting the brake pad or the like, a sharp end edge of the elastic member constituting the pad clip and the surface of the guide projected portion formed at the support member can be prevented from rubbing each other. Therefore, even when the lining of the brake pad is unevenly worn, a relative displacement between the brake pad and the support member can smoothly be carried out.

In this case, when the structure of the fourth aspect is adopted, even when the lining constituting the brake pad is worn and a front end portion of the guide plate portion and the side face of the rotor rub each other, the sharp end edge of the elastic member constituting the pad clip and the side face of the rotor do not rub each other. Only the smooth side face portion of the elastic member and the side face portion of the rotor rub each other. Therefore, even when the lining is worn, the side face of the rotor can be made to be difficult to be damaged.

Further, according to the structure of the fifth aspect, it can be known that the lining is worn to the wear allowable limit thickness by utilizing the pad clip. Therefore, it is not necessary to separately integrate the wear indicator, any of part fabrication, part control, assembling operation can be simplified, and a reduction in cost of the disc brake can be achieved.

Further, according to the structure of the sixth aspect, the pad clip can be prevented from being drawn from the opening portion of the guide recessed portion, and the pad clip can further firmly be prevented from being detached from the brake pad.

Other aspects and advantages of the invention will be apparent from the following description and the appended claims.

### BRIEF DESCRIPTION OF THE DRAWINGS

FIG. 1 is a view showing a disc brake of a first exemplary embodiment of the invention omitting a caliper from an outer side.

FIG. 2 is a view showing the disc brake from an inner side.

FIG. 3 is a view showing a brake pad on an outer side mounted with a pad clip from a direction the same as that of FIG. 1.

FIG. 4 is a perspective view taking out to show an outer side pad clip.

FIGS. 5(A) to 5(C) illustrate regularly projected views of the pad clip, FIG. 5(A) is a view showing the pad clip in directions the same as those of FIGS. 1, 3, FIG. 5(B) is a view showing the pad clip from an upper side of FIG. 5(A), FIG. 5(C) is a view showing the pad clip from a right side of FIG. 5(A) FIGS. 6(A) to 6(C) illustrate views similar to FIGS. 5(A) to 5(C) showing a second exemplary embodiment of the invention.

FIGS. 7(A) to 7(C) illustrate views similar to FIGS. 5(A) to 5(C) showing a third exemplary embodiment.

FIGS. 8(A) and 8(B) illustrate views in correspondence with X portion of FIG. 7(C) showing other examples of shapes of hold plate portions.

FIGS. 9(A) to 9(C) illustrates views similar to FIGS. 5(A) to 5(C) showing a fourth exemplary embodiment of the invention.

FIGS. 10(A) and 10(B) illustrate views for explaining operation of the fourth exemplary embodiment, FIG. 10(A) is an outline view showing from a direction of rotating a rotor, and FIG. 10(B) is a view partially enlarging FIG. 10(A).

FIG. 11 is a view similar to FIG. 9 (C) showing a fifth exemplary embodiment of the invention.

FIGS. 12(A) to 12(C) illustrate views similar to FIGS. 5(A) to 5(C) showing a sixth exemplary embodiment.

FIGS. 13(A) to 13(C) illustrate views similar to FIGS. 5(A) to 5(C) showing a seventh exemplary embodiment.

FIG. 14 is an outline view showing from a radial direction of the rotor for explaining operation of the example.

FIGS. 15(A) to 15(C) illustrates views similar to FIGS. 5(A) to 5(C) showing an eighth exemplary embodiment.

FIG. 16 is a view similar to FIG. 4 showing a ninth exemplary embodiment.

FIG. 17(A) to 17(C) illustrate views similar to FIGS. 5(A) to 5(C) showing the ninth exemplary embodiment.

FIG. 18 is a view similar to FIG. 17 (C) showing an example of a structure of projecting a plate portion for a wear indicator on both sides.

FIG. 19 is a perspective view showing a portion of a support member applying the invention also to a portion of integrating an inner side brake pad.

FIG. 20 is a view similar to FIG. 1 showing an example of a background art structure.

FIG. 21 is a view showing from an upper side of FIG. 20 by cutting a portion thereof.

FIG. 22 is a perspective view showing a portion of a support member.

### DETAILED DESCRIPTION OF THE EXEMPLARY EMBODIMENTS

### First Exemplary Embodiment

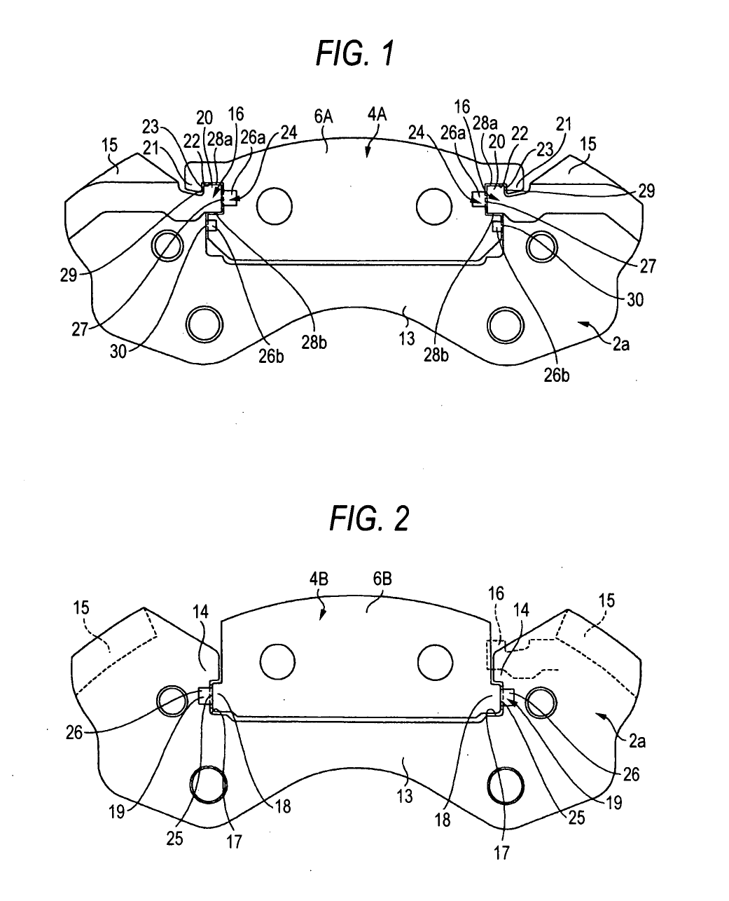

FIGS. 1 through 5(C) show a first exemplary embodiment of the invention. The exemplary embodiments of the invention including the first exemplary embodiment is characterized in a structure of portions of supporting two end portions of a pressure plate 6A constituting a brake pad 4A on an outer side by a support member 2a. An explanation will be given of a constitution of the support member 2a in reference to FIGS. 1 through 2.

The support member 2a is integrally fabricated by bending a sheet of a thick-walled steel plate or the like, and includes a base plate portion 13 substantially in a channel-like shape provided adjacent to the rotor 1 and respective pairs of inner pad support portions 14, 14, connecting plate portions 15, 15, and guide projected portions 16, 16 on an inner side (reverse side of FIG. 1, obverse side of FIG. 2) with regard to the rotor 1 (refer to FIG. 21).

The inner pad support portions 14, 14 among these are provided at portions proximate to both ends of the base plate portions 13 with regard to a peripheral direction of the rotor 1, and support both end portions in a peripheral direction of a pressure plate 6B constituting a brake pad 4B on the inner side to be able to be displaced in the axial direction (obverse and reverse directions of FIGS. 1 through 2) of the rotor 1. For that purpose, the two inner pad support portions 14, 14 are formed with locking grooves 17, 17 (refer to FIG. 2) in a channel-like shape at side faces thereof opposed to each other in a state of being opened to face each other. According to the pressure plate 6B, a pair of locking projected portions 18, 18 provided at two end portions thereof with regard to the peripheral direction of the rotor 1 are engaged with the two locking grooves 17, 17 by way of inner side pad clips 19, 19 to be able to be displaced in the axial direction of the rotor 1. Under the state, the brake pad 4B on the inner side is supported between the two inner pad support portions 14, 14 to be able to be displaced in the axial direction of the rotor 1.

Further, the two connecting plate portions 15, 15 are folded to bend to the outer side from outer peripheral edge portions of two end portions in a peripheral direction of the base plate portion 13 and in a state of being attached to a vehicle body, inner peripheral faces of the two connecting plate portions 15, 15 and an outer peripheral edge of the rotor 1 are opposed to each other. Further, the two guide projected portions 16, 16 are extended from front end portions of the two connecting plate portions 15, 15 in directions of being proximate to each other. Further, front end portions of the two guide projected portions 16, 16 are provided with a pair of locking portions 20, 20 folded to bend to an outer side in a radial direction of the rotor 1. Stepped portions 23, 23 are provided between the two locking portions 20, 20 and base half portions of the two guide projected portions 16, 16.

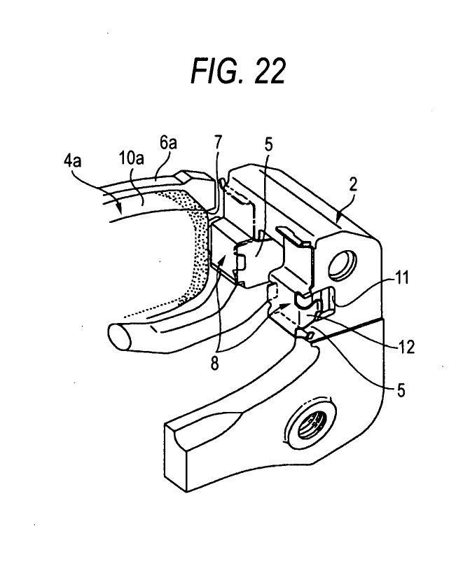

On the other hand, locking hook portions 21, 21 in an L-like shape are provided at end portions on outer diameter sides of two end portions in a peripheral direction of the pressure plate 6A constituting the brake pad 4A on the outer side. Further, guide recessed portions 22, 22 are respectively formed at portions of two end edge portions in the peripheral direction of the pressure plate 6A contiguous to inner diameter sides of the two locking hook portions 21, 21. Further, front end portions of the two guide projected portions 16, 16 are engaged with the two guide recessed portions 22, 22 by way of pad clips 24, 24 on an outer side to be able to be displaced relatively in the axial direction of the rotor 1. Under the state, the two stepped portions 23, 23 and the locking hook portions 21, 21 formed at the two end portions in the peripheral direction of the pressure plate 6A are engaged by way of the two pad clips 24, 24 on the outer side. In braking, a brake torque applied to the brake pad 4A based on friction between the rotor 1 and the lining 10a (refer to FIGS. 21, 22) on the outer side is supported by a contact portion of a front end face of the guide projected portion 16 on an outer side of the rotation and a depth face of the guide recessed portion 22 on the outer side of rotation, and an engaging portion of the stepped portion 23 with regard to the guide projected portion 16 on an inner side of rotation and the locking hook portion 21 on the inner side of rotation.

In the respective inner side and outer side pad clips 19, 24 integrated to the disc brake constituted as described above, the inner side pad clips 19, 19 are fabricated by bending to form metal plates having corrosion resistance and elasticity of stainless steel plates or the like. A simple explanation will be given of the two inner side pad clips 19, 19. The two inner side pad clips 19, 19 include main plate portions 25 bent in accordance with inner side faces of the two inner pad support portions 14, 14, and hold plate portions 26 folded to bend from two side edges of the main plate portions 25 in the same direction. Such two inner side pad clips 19, 19 are mounted to the two inner pad support portions 14, 14 in a state of butting the main plate portions 25 to the inner side faces of the two inner pad support portions 14, 14 and holding the inner pad support portions 14, 14 by respective pairs of the hold plate portions 26.

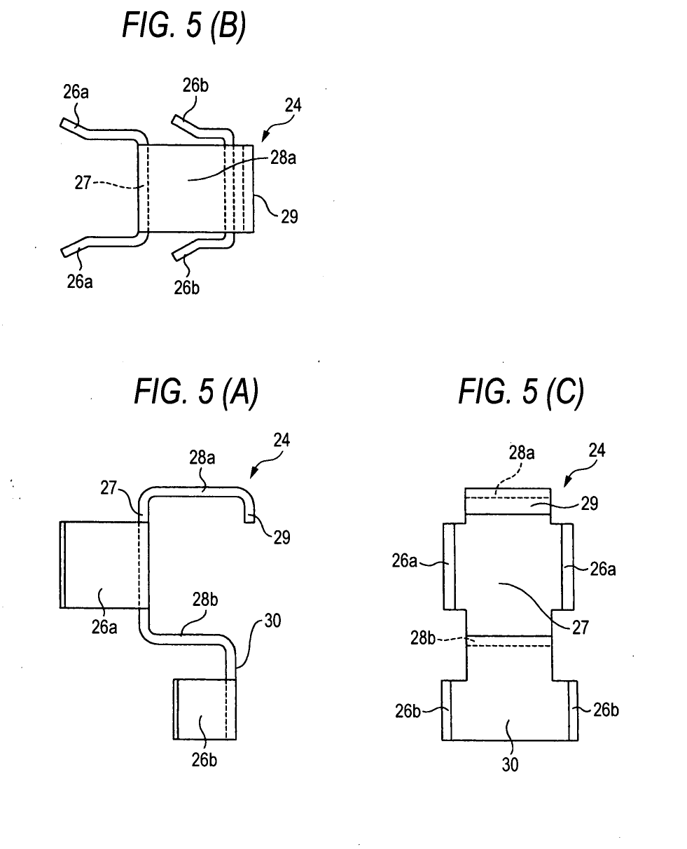

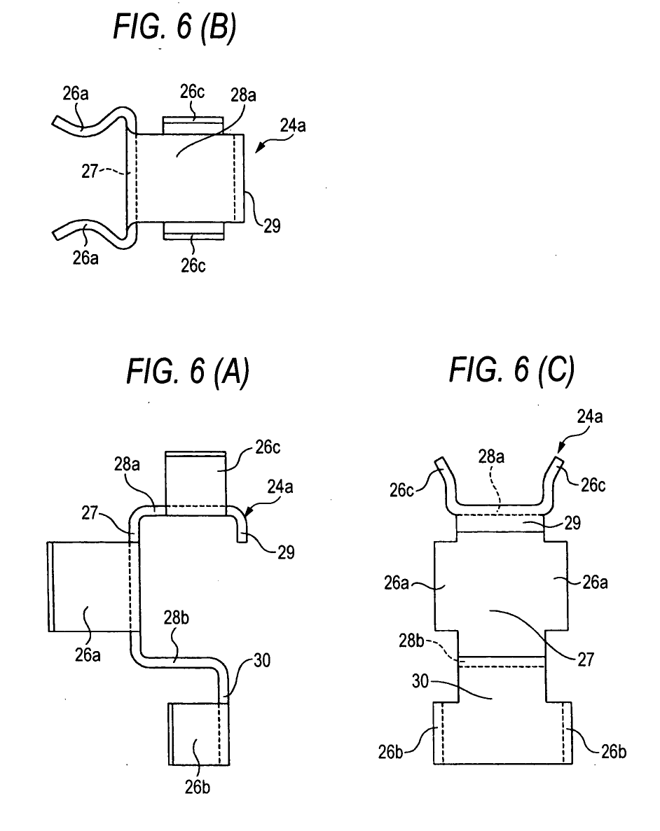

On the other hand, two outer side pad clips 24, 24 are fabricated by a shape shown in FIGS. 4 through 5 in details by bending to form metal plates having corrosion resistance and elasticity of stainless steel plates or the like. That is, the two outer side pad clips 24, 24 include base plate portions 27, pairs of elastic plate portions 28a, 28b, and two pairs of outer diameter side and inner diameter side hold plate portions 26a, 26b. Among these, the base plate portions 27 are constituted by a flat plate shape and provided with a shape and a size capable of being butted to depth end faces of the two guide recessed portions 22, 22 formed at the two end edge portions in the peripheral direction of the pressure plate 6A. Further, the two elastic plate portions 28a, 28b are folded to bend from both end portions of the base plate portion 27 in the same direction, and is provided with an elastic force in directions the more directed to front end edges (the more remote from the base plate portion 27), the more enlarged the interval in a free state.

In the two elastic plate portions 28a, 28b, a front end portion of the elastic plate portion 28a disposed on an outer side (upper side of FIGS. 1, 4) with regard to the radial direction of the rotor 1 is formed with an outer diameter side fold-to-bend plate portion 29 by being folded to bend to the inner side with regard to the radial direction. The outer diameter side fold-to-bend plate portions 29 are squeezed between the locking hook portions 21, 21 and the stepped portions 23, 23 in a state of integrating the disc brake. Thereby, corrosion resistance between the locking hook portions 21, 21 and the stepped portions 23, 23 is promoted. On the other hand, front end portions of the elastic plate portions 28b disposed on an inner side (lower side of FIGS. 1, 4) with regard to the radial direction are formed with inner diameter side fold-to-bend plate portions 30 by being folded to bend to an inner side with regard to the radial direction.

In the respective hold plate portions 26a, 26b, a pair of outer diameter side hold plate portions 26a, 26a provided at both side edges of the base plate portion 27 in a state of being folded to bend to the pressure plate 6A are respectively constituted by a L-like shape, and an interval therebetween is narrowed at middle portions through base end portions. In a free state, the interval at the narrowed portion is smaller than a thickness of the pressure plate 6A and an interval between front end edge portions thereof is larger than the thickness. Also the pair of inner diameter side hold plate portions 26b, 26b provided at both side edges of the inner diameter side fold-to-bend plate portion 30 in a state of being folded to bend to the pressure plate 6A are constituted by substantially a similar shape.

The two outer side pad clips 24, 24 constituted as described above are inserted to inner sides of the two guide recessed portions 22, 22 formed at the two end edge portions in the peripheral direction of the pressure plate 6A in a state of elastically contracting the intervals between the two elastic plate portions 28a, 28b. By releasing forces which have restrained the two elastic plate portions 28a, 28b after insertion, the two elastic plate portions 28a, 28b are elastically pressed to opposed side faces with regard to the radial direction of the rotor 1 in inner faces of the two guide recessed portions 22, 22. Under the state, by the respective hold plate portions 26a, 26b, two end edge portions in the peripheral direction of the pressure plate 6A are squeezed from two inner and outer sides. The outer side fold-to-bend plate portion 29 is engaged with the locking hook portion 21. Under the state, the two outer side pad clips 24, 24 are mounted to the two end edge portions in the peripheral direction of the pressure plate 6A. In this way, an operation of mounting the two outer side pad clips 24, 24 to the side of the brake pad 4A can easily be carried out. In contrast thereto, when intended to be mounted to the side of the support member 2a, the two elastic plate portions 28a, 28b need to be deformed in directions of being opened until a state in which the outer diameter side fold-to-bend plate portion 29 rides over the respective locking portions 20, 20 of the respective guide projected portions 16, 16. Therefore, the two elastic plate portions 28a, 28b are liable to be deformed permanently, which is not preferable.

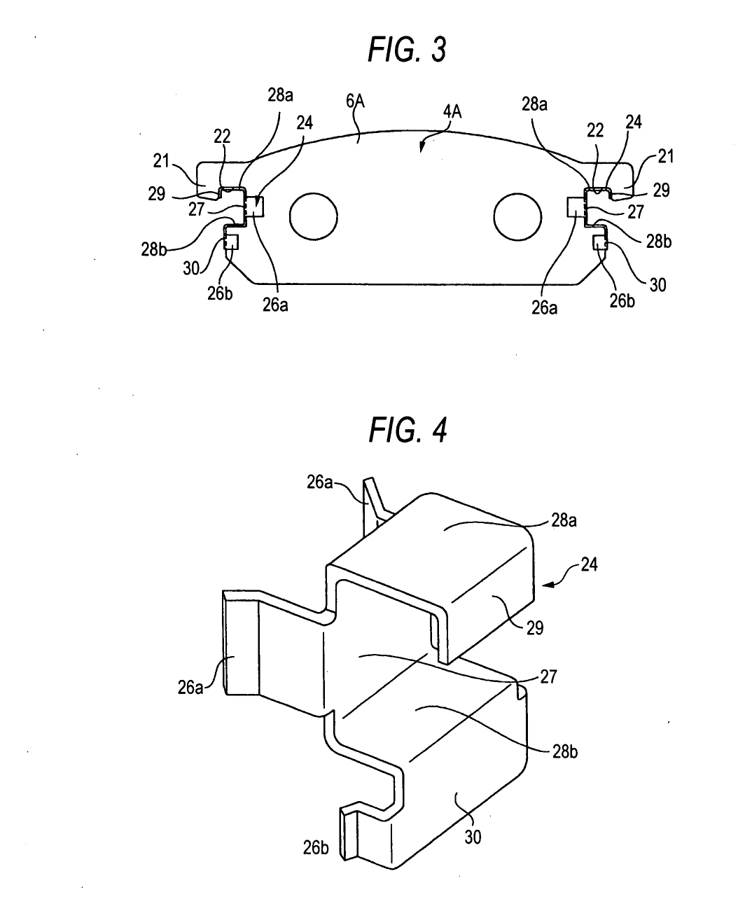

According to the disc brake of the exemplary embodiment in which the two outer side pad clips 24, 24 constituted as described above are mounted to the two end edge portions in the peripheral direction of the pressure plate 6A as described above, even in a state before mounting the brake pad 4A on the outer side to the support member 2a, the tacked two outer side pad clips 24, 24 are difficult to be detached. That is, the two outer side pad clips 24, 24 are prevented from being shifted in an obverse and reverse direction of FIG. 3 based on engagement between the respective hold plate portions 26a, 26b and the pressure plate 6A. Further, the two outer side pad clips 24, 24 are prevented from being drawn from the two guide recessed portions 22, 22 based on a friction engagement between the two elastic plate portions 28a, 28b and the inner faces of the two guide recessed portions 22, 22 and an engagement between the outer diameter side fold-to-bend plate portion 29 and the locking hook portions 21. Therefore, the two outer side pad clips 24, 24 are not unpreparedly detached from the brake pad 4A on the outer side.

In addition, there can be realized a structure in which the operator is difficult to be injured at the hand, the finger or the like by improving a performance of handling the brake pad 4A on the outer side mounted with the two outer side pad clips 24, 24. That is, the outer side pad clips 24, 24 are mounted to the guide recessed portions 22, 22 provided on the side of the brake pad 4A constituting a comparatively small-sized and light-weighted brake pad in the support member 2a and the brake pad 4A integrated together by way of the two outer side pad clips 24, 24 and provided in a state of being recessed to the inner side at the brake pad 4A. Therefore, in being carried at inside of the factory of assembling the disc brake, even when the two outer side pad clips 24, 24 collide with other article, the two outer side pad clips 24, 24 are not detached or damaged. Since constituted by subjecting the metal plate to punching and bending by a press, the brake pad 4A mounted with the outer side pad clips 24, 24 is small-sized and light-weighted. Therefore, even when the operator handles the brake pad 4A by the hand for assembling, the operator is difficult to be injured at the hand, the finger or the like by the sharp end. In contrast thereto, when the two outer side pad clips 24, 24 are mounted to the guide projected portions 16, 16 of the support member 2a, the two outer side pad clips 24, 24 are brought into a state of being exposed to the outer side. Therefore, there is a possibility that the two outer side pad clips 24, 24 are detached or damaged in handling by manual labor or interfering with other article, further, in being tentatively placed in a state of being tacked to the respective guide projected portions 16, 16.

### Second Exemplary Embodiment

FIGS. 6(A) to 6(C) show a second exemplary embodiment of the invention. In the case of the second exemplary embodiment, a pair of hold plate portions 26c, 26c respectively folded to bend to an outer side in the radial direction of the rotor 1 are formed at the two side edges of the elastic plate portion 28a disposed on the outer side {outer side of FIG. 6 (A)} in the radial direction of the rotor 1 (refer to FIG. 21) in the pair of elastic plate portions 28a, 28b. In a state of mounting the outer side pad clips 24a of the example to the guide recessed portions 22, 22 (refer to FIGS. 1, 3) formed at the pressure plate 6A constituting the brake pad 4A on the outer side, positioning of the outer side pad clip 24a in the obverse and reverse direction of the pressure plate 6A is achieved by 3 pairs of the hold plate portions 26a, 26b, 26c. In the case of the outer side pad clip 24a shown in FIGS. 6(A) to 6(C), a shape of the hold plate portions 26a, 26a is constituted by a hat shape, an interval between such hold plate portions 26a, 26a in a free state is smaller than the thickness of the pressure plate 6A at middle portions thereof and larger than the thickness at front end portions thereof.

Constitution and operation of other portion are similar to those of the case of the first exemplary embodiment mentioned above, and therefore, duplicated illustration and explanation thereof will be omitted.

### Third Exemplary Embodiment

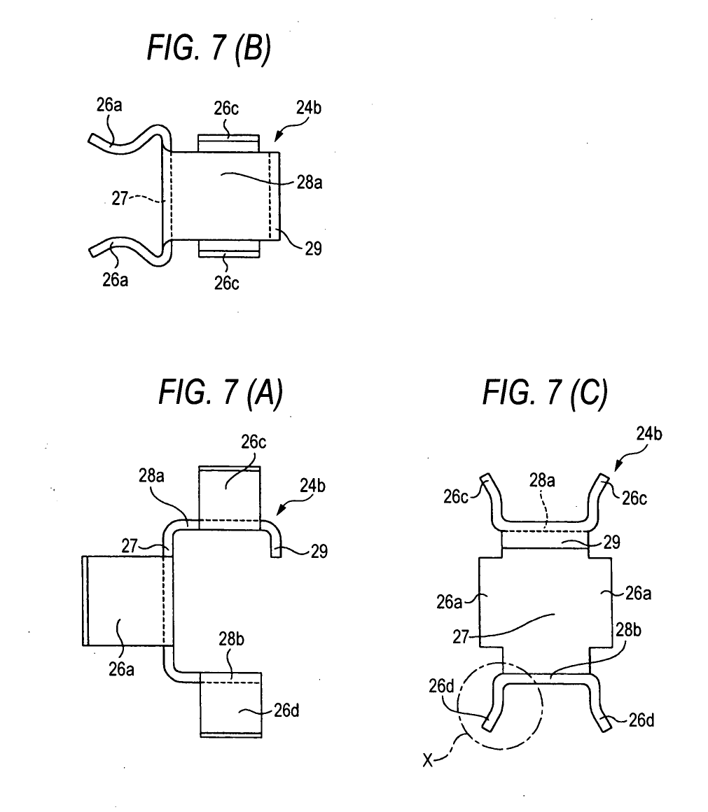

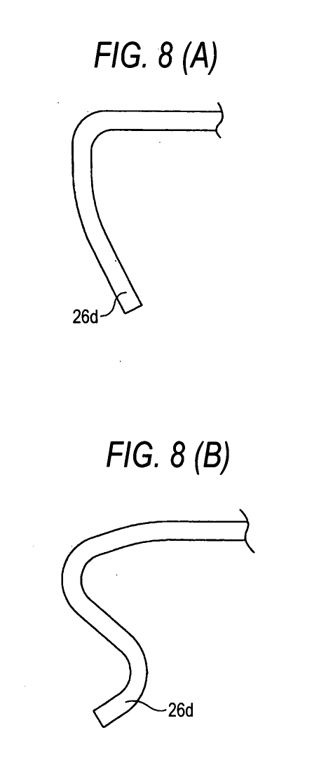

FIGS. 7(A) through 8(B) show a third exemplary embodiment of the invention. In the case of the third exemplary embodiment, the inner diameter side fold-to-bend plate portion 30 (refer to FIGS. 6(A) to 6(c)) is omitted. In place thereof, a pair of hold plate portions 26d, 26d respectively folded to bend to the inner side in the radial direction of the rotor 1 are formed at both side edges of the elastic plate portion 28b disposed on the inner side {lower side of FIG. 7 (A)} with regard to the radial direction of the rotor 1 (refer to FIG. 21) in the pair of elastic plate portions 28a, 28b. In a state in which the outer side pad clips 24b of the example are amounted to the guide recessed portions 22, 22 (refer to FIGS. 1, 3) formed at the pressure plate 6A constituting the brake pad 4A on the outer side, positioning of the outer side pad clips 24b with regard to the obverse and reverse direction of the pressure plate 6A is achieved by 3 pairs of hold plate portions 26a, 26c, 26d.

Further, in the case of the outer side pad clip 24b shown in FIGS. 7(A) to 7(C), similar to the second exemplary embodiment, the shape of the hold plate portions 26a, 26a is constituted by a hat shape. Also with regard to remaining two pairs of the hold plate portions 26c, 26d, the shape is not limited to a L-shape shown in FIG. 7(A) to 7(C) but may be a circular arc shape as shown by FIG. 8 (A), or an S-like shape as shown by FIG. 8(B) of the drawing.

Constitution and operation of other portion are similar to those in the case of the second exemplary embodiment, and therefore, duplicated illustration and explanation are omitted.

### Fourth Exemplary Embodiment

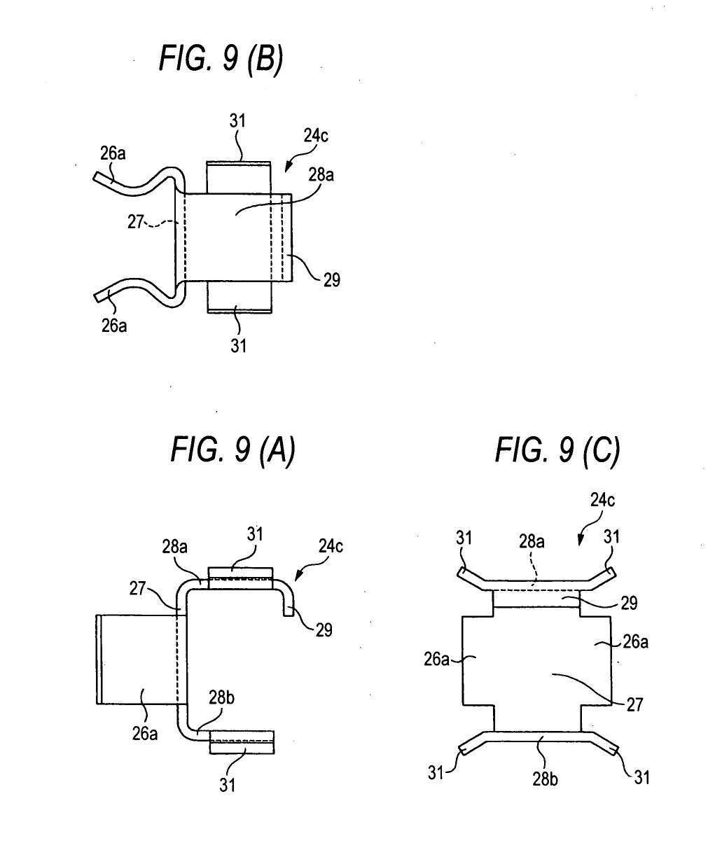

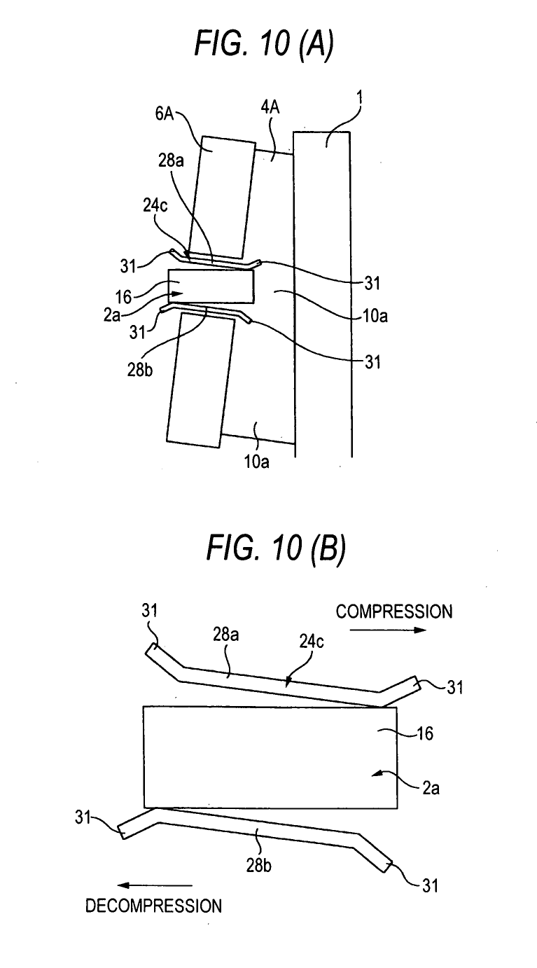

FIGS. 9(A) through 10(B) show a fourth exemplary embodiment of the invention. In the case of the fourth exemplary embodiment, both end edge portions of the pair of elastic plate portions 28a, 28b are formed with guide plate portions 31, 31 inclined in directions the more remote from the both end edge portions of the two elastic plate portions 28a, 28b, the more inclined in the directions of being remote from the guide projected portion 16 formed at the support member 2a with regard to the radial direction of the rotor 1 in place of the remaining two pairs of hold plate portions 26c, 26d provided in the case of the third example of the embodiment mentioned above. In sum, although the interval between the two elastic plate portions 28a, 28b substantially coincides with (coincides with or slightly larger than) the width dimensions of the two guide projected portions 16, the interval between the two guide plate portions 31, 31 is made to be larger than the width dimension of the two guide projected portions 16, 16 as being remote from the two elastic plate portions 28a, 28b.

According to the structure of the fourth exemplary embodiment including the two guide plate portions 31, 31 mentioned above, as shown by FIG. 10 (A), even when the pressure plate 6A constituting the brake pad 4A tends to be inclined in braking relative to the support member 2a by an uneven wear of the lining 10a constituting the brake pad 4A on the outer side with regard to the radial direction of the rotor 1, it can be prevented that face pressures between sharp end edges of the elastic members of the stainless steel plates or the like constituting outer side pad clips 24c and surfaces of the two guide projected portions 16, 16 become extremely high. Therefore, even when the lining 10a constituting the brake pad 4A on the outer side is unevenly worn, a relative displacement between the brake pad 4A and the support member 2a in braking and in releasing can smoothly be carried out. Further, even in a case in which the pressure plate 6A tends to be inclined by reason other than uneven wear, for example, owing to accuracies of respective parts can similarly be dealt with.

Constitution and operation of other portion are similar to those in the case of the third exemplary embodiment, and therefore, duplicated illustration and explanation will be omitted.

### Fifth Exemplary Embodiment

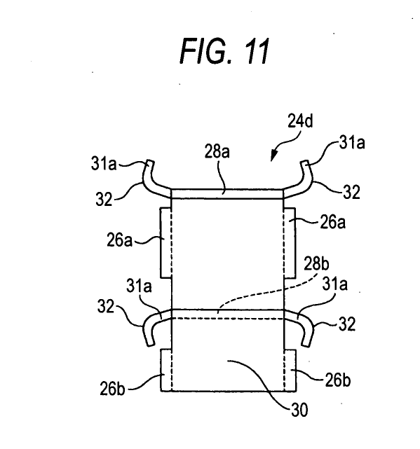

FIG. 11 shows a fifth exemplary embodiment of the invention. In a case of the fifth exemplary embodiment, front end portions of a pair of guide plate portions 31a, 31a are folded back. Therefore, in a state of integrating an outer side pad clip 24d of the exemplary embodiment to the disc brake, folded-back portions 32, 32 in a shape of a projected circular arc are opposed to the side face of the rotor 1 {refer to FIG. 10 (A)}. Therefore, regardless of wear of the lining 10a (refer to FIGS. 10(A) and 10(B)) constituting the brake pad 4A on the outer side, it can be prevented that the front end edges of the two guide plate portions 31a, 31a made of metal plates and the side face of the rotor 1 rub each other to considerably damage the side face of the rotor 1. Further, the operator can also be prevented from being injured at the hand or the finger.

Constitution and operation of other portion are similar to those of the cases of the first exemplary embodiment and the fourth exemplary embodiment, and therefore, duplicated illustration and explanation will be omitted.

### Sixth Exemplary Embodiment

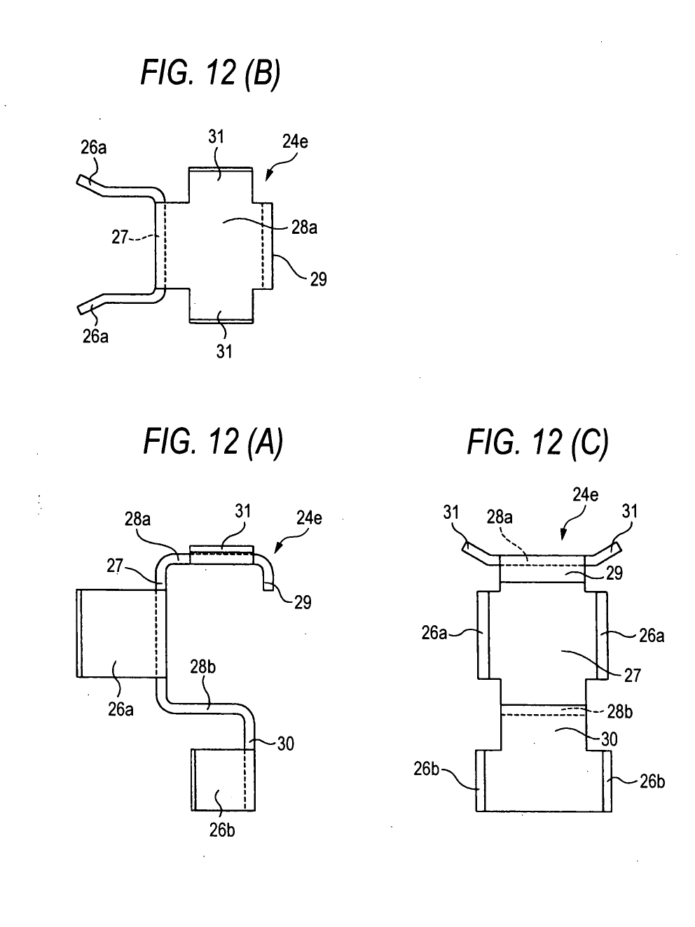

FIGS. 12(A) to 12(C) show a sixth exemplary embodiment of the invention. In a case of an outer side pad clip 24e of the sixth exemplary embodiment, the structure of the first exemplary embodiment is formed with the guide plate portions 31, 31 at the both side edges of the elastic plate portion 28a on the outer diameter side. Although guide plate portions are not provided with regard to the elastic plate portion 28b on the inner diameter side, the guide plate portions may be provided.

Constitution and operation of other portion are similar to those of the fourth exemplary embodiment, and therefore, duplicated illustration and explanation will be omitted.

### Seventh Exemplary Embodiment

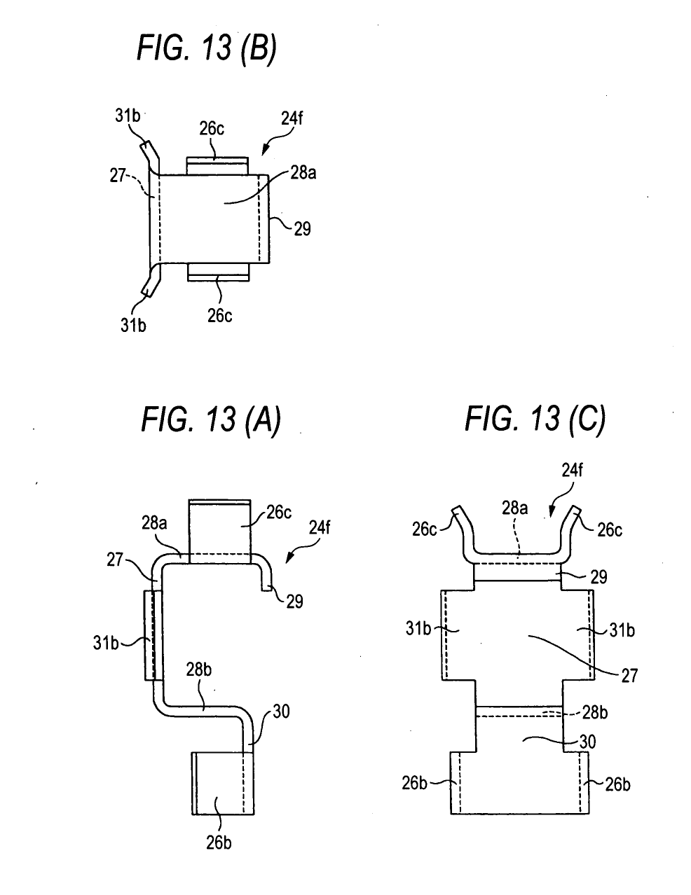

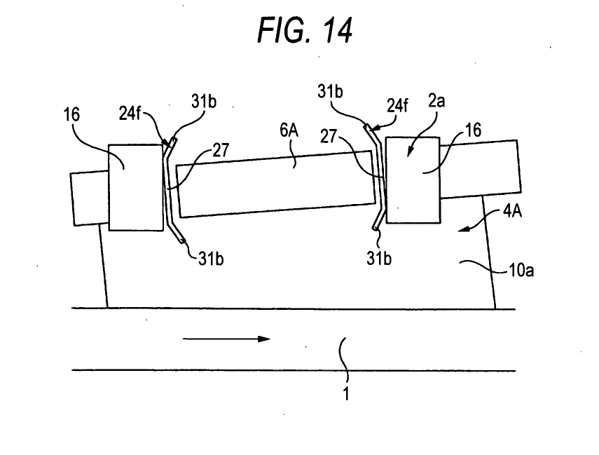

FIGS. 13(A) through 14 show a seventh exemplary embodiment of the invention. In a case of an outer side pad clip 24f of the seventh exemplary embodiment, the both end edge portions of the base plate portion 27 are formed with guide plate portions 31b, 31b inclined in directions the more remote from the both end edge portions of the base plate portion 27, the more remote from the guide projected portions 16, 16 (refer to FIG. 1) formed at the support member 2a with regard to the direction of rotating the rotor 1 in place of the hold plate portions 26a, 26a (refer to FIGS. 4 through 5) provided in the case of the first exemplary embodiment.

According to the structure of the seventh embodiment including the two guide plate portions 31b, 31b as mentioned above, as shown by FIG. 14, even when the pressure plate 6A constituting the brake pad 4A tends to be inclined in braking relative to the support member 2a by uneven wear of the lining 10a constituting the brake pad 4A on the outer side with regard to the direction of rotating the rotor 1 (a wear amount on the inner side of rotation of the rotor 1 is increased), it can be prevented that face pressures between the sharp end edges of the elastic members of the stainless steel plates or the like constituting the outer side pad clip 24f and the surfaces of the two guide projected portions 16, 16 become extremely high. Therefore, even when the lining 10a constituting the brake pad 4A on the outer side is unevenly worn, a relative displacement between the brake pad 4A and the support member 2a can smoothly be carried out.

Constitution and operation of other portion are similar to those of the case of the first through the second exemplary embodiments, and therefore, duplicated illustration and explanation will be omitted.

### Eighth Exemplary Embodiment

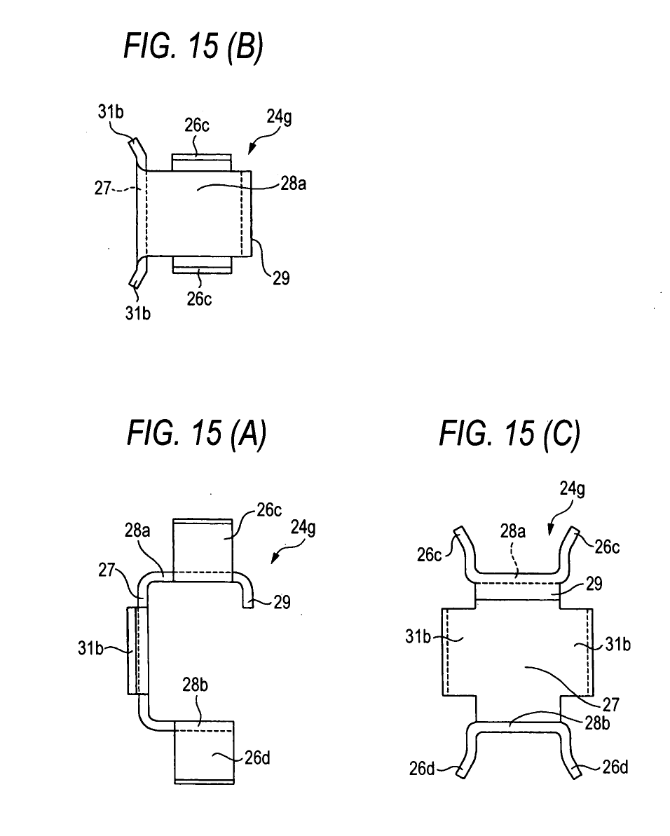

FIG. 15(A) shows an eighth exemplary embodiment of the invention. In a case of an outer side pad clip 24g of the eighth exemplary embodiment, both side edges of the elastic plate portion 28a in the pair of the elastic plate portions 28a, 28b which is disposed on the outer side {upper side of FIG. 15 (A)} with regard to the radial direction of the rotor 1 (refer to FIG. 21) are formed with a pair of hold plate portions 26c, 26c respectively folded to bend to the outer side in the radial direction of the rotor 1. In a state in which the outer side pad clips 24g of the example are mounted to the guide recessed portions 22, 22 (refer to FIGS. 1, 3) formed at the pressure plate 6A constituting the brake pad 4A on the outer side, positioning of the outer side pad clips 24g in the obverse and reverse direction of the pressure plate 6A is achieved by two pairs of the inner diameter side and the outer diameter side hold plate portions 26c, 26d.

Constitution and operation of other portion are similar to those of the cases of the third exemplary embodiment and the seventh exemplary embodiment, and therefore, duplicated illustration and explanation will be omitted.

### Ninth Exemplary Embodiment

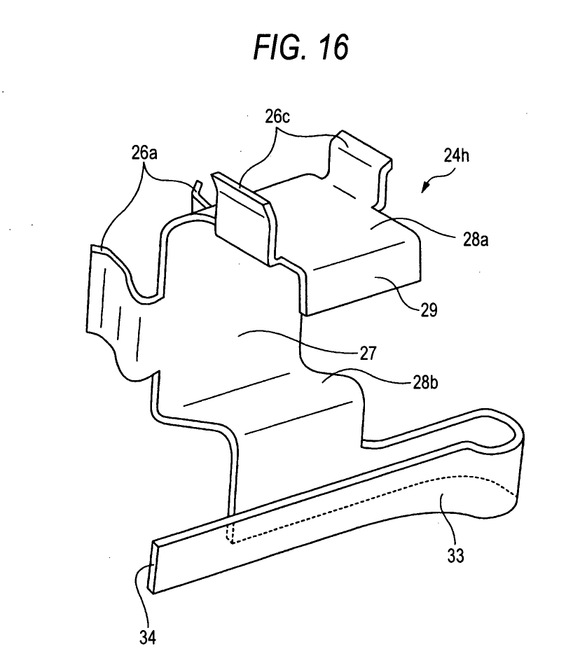

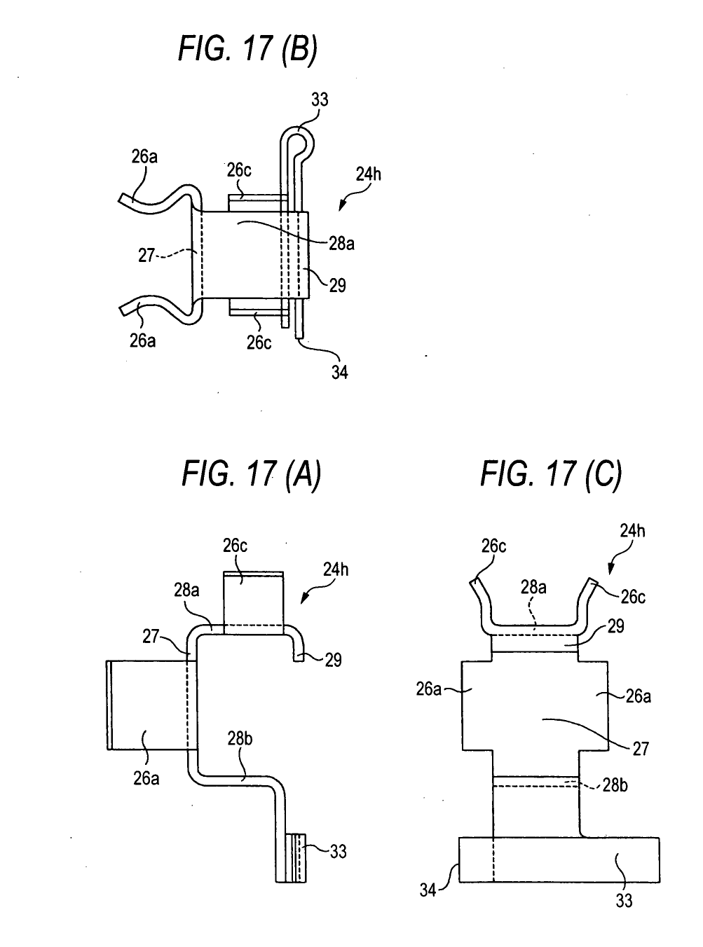

FIGS. 16 through 17(C) show a ninth exemplary embodiment of the invention. In a case of an outer side pad clip 24h of the ninth exemplary embodiment, a portion of the outer side pad clip 24h is provided with a plate portion for a wear indicator 33 projected to the side face of the rotor 1 (refer to FIG. 21). In the case of the outer side pad clip 24h of the example provided with the plate portion for the wear indicator 33 in this way, a front end edge 34 of the plate portion for the wear indicator 33 is arranged at a wear allowable limit thickness position of the lining 10a (refer to FIGS. 21 through 22) constituting the brake pad 4A on the outer side.

According to the structure of the ninth exemplary embodiment, it can be known that the lining 10a is worn to the wear allowable limit thickness by utilizing the outer side pad clip 24h. That is, when the lining 10a is worn to the wear allowable limit thickness, the front end edge 34 of the plate portion for the wear indicator 33 and the side face of the rotor 1 rub each other, the plate portion for the wear indicator 33 is vibrated to emit alarm sound for urging an operator to interchange the brake pad. Therefore, it is not necessary to separately integrate the wear indicator, any of part fabrication, part control, assembling operation can be simplified and a reduction in cost of the disc brake can be achieved.

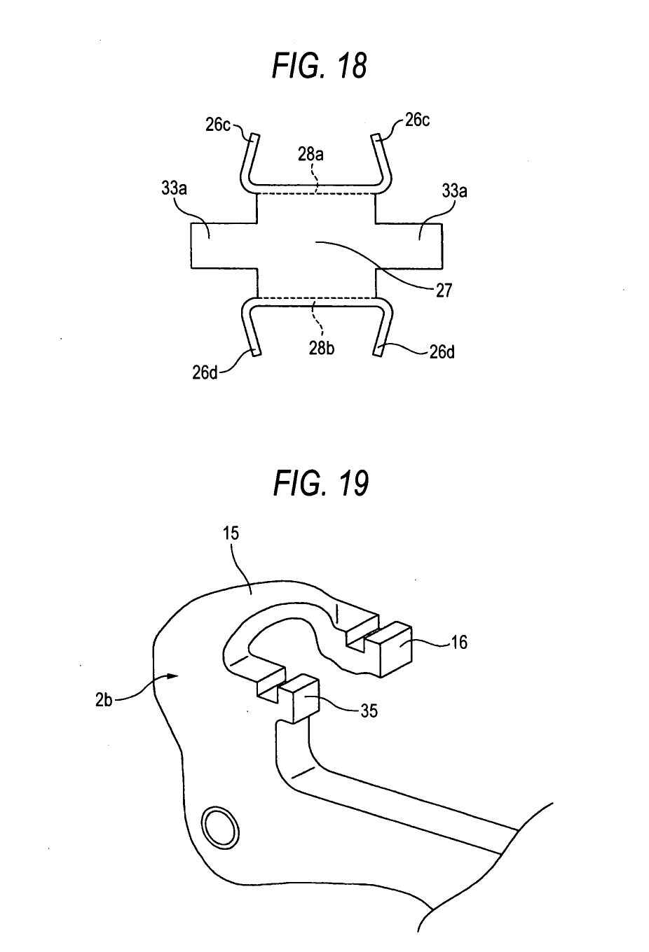

Further, as shown by FIG. 18, when plate portions for the wear indicators 33a, 33a are projected on both sides, it is not necessary to restrict a direction of integrating the outer side pad clip, and part fabrication, part control of the outer side pad clip, and the assembling operation of the disc brake can be facilitated.

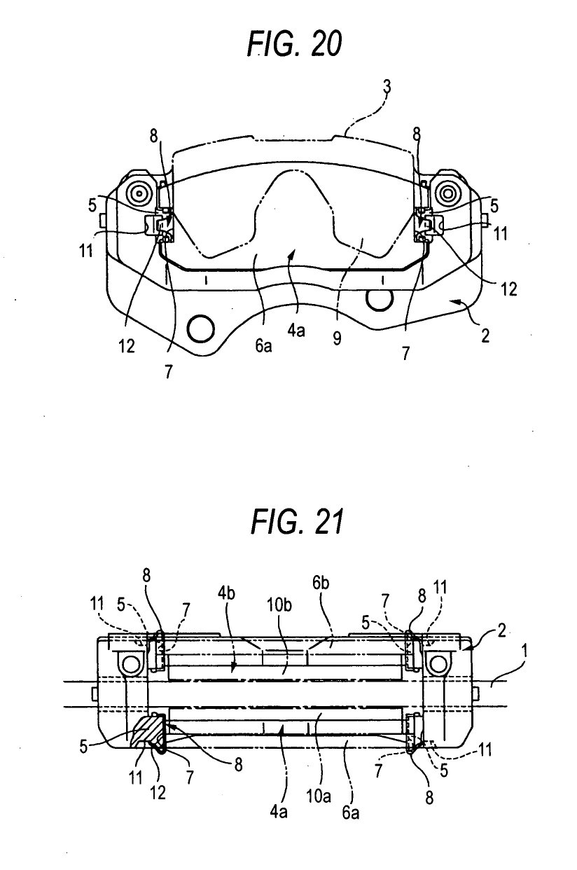

The structure of the invention is not limited to the disc brake including the illustrated support member made of sheet metal but is applicable also to a disc brake including the support member made by die cast shown in FIGS. 20 through 22 mentioned above. Further, when a support member 2b including an inner side guide projected portion 35 is used as shown by FIG. 19 in place of the inner pad support portion, the structure is applicable not only to the portion of integrating the brake pad on the outer side to the support member but also to a portion of integrating the brake pad on the inner side to the support member. In this case, the brake pads are not differentiated to the inner side and the outer side but can be made common.

Further, although according to the outer side pad clip shown in the exemplary embodiments, the outer diameter side fold-to-bend plate portion 29 is formed with an object of promoting corrosion resistance, wear resistance between the locking hook portion 21 and the stepped portion 23, the respective portions 21, 23 may directly be engaged with each other by omitting the outer diameter side fold-to-bend plate portion 29 in accordance with use of the embodiments.

While the invention has been described with reference to the exemplary embodiments and variations thereof, the technical scope of the invention is not restricted to the description of the exemplary embodiment and variations thereof. It is apparent to the skilled in the art that various changes or improvements can be made. It is apparent from the description of claims that the changed or improved configurations can also be included in the technical scope of the invention.

What is claimed is:

1. A disc brake comprising:
a support member fixed to a vehicle body adjacent to a rotor rotated along with a wheel;
a brake pad supported by the support member;
a guide projected portion formed on the support member and projected to a pressure plate of the brake pad;
a guide recessed portion formed on the pressure plate and recessed relative to the support member; and
a pad clip, wherein the guide projected portion and the guide recessed portion are engaged by way of the pad clip,
wherein the pad clip is made by an elastic plate and comprises:
a base plate portion; and
a pair of elastic plate portions folded to bend in the same direction from both end portions of the base plate portion and provided with an elastic force in a direction of expanding an interval between the two elastic plate portions, and
the pad clip is mounted to the pressure plate by inserting the pad clip to an inner side of the guide recessed portion in a state of elastically contracting the interval between the two elastic plate portions and elastically pressing the pad clip to side faces of inner faces of the guide recessed portion opposed to each other with regard to a radial direction of the rotor.

2. The disc brake according to claim 1, further comprising:
at least a pair of hold plate portions folded to bend toward the pressure plate and formed at both end edge portions with regard to an axial direction of the rotor of any of plate portions constituting the pad clip, wherein by squeezing the pressure plate from both obverse and reverse sides thereof by the hold plate portions, positioning of the pad clip with regard to an obverse and reverse direction of the pressure plate is achieved.

3. The disc brake according to claim 1, further comprising:
a guide plate portion inclined in a direction of being remote from the guide projected portion as being remote from any of the plate portions, the guide plate being formed on an end edge portion of any of the plate portions constituting the pad clip with regard to the axial direction of the rotor.

4. The disc brake according to claim 3, wherein a front end portion of the guide plate portion is folding to bend, so that a sharp end edge of the guide plate portion and a side face of the rotor are prevented from rubbing each other, regardless of wear of a lining of the brake pad.

5. The disc brake according to claim 1, further comprising:
a plate portion for a wear indicator provided on the pad clip and projected to the side face of the rotor, wherein a front end edge of the plate portion for the wear indicator is arranged at a wear allowable limit thickness position of the lining of the brake pad.

6. The disc brake according to claim 1, wherein a front half portion of the guide projected portion is folded to bend relative to a base half portion thereof,
a stepped portion is present between the front half portion and the base half portion,
a portion of the pressure plate is provided with a locking hook portion folded to bend to an opening portion of the guide recessed portion,
at least a portion of a brake torque applied to the brake pad based on friction between the rotor and the lining in braking is made to be able to be supported by an engagement between the locking hook portion and the stepped portion, and
the pad clip is prevented from being drawn from the opening portion of the guide recessed portion by an engagement between a front end edge of any of the elastic plate portions and the locking hook portion.
